(19) United States
(12) Patent Application Publication
(10) Pub. No.: US 2014/0055640 A1
(43) Pub. Date: Feb. 27, 2014

(54) RECORDING CONTROL APPARATUS, RECORDING CONTROL METHOD, AND PROGRAM

(71) Applicant: Sony Corporation, Tokyo (JP)

(72) Inventors: KEI KAWAI, Tokyo (JP); YOICHI MOTOKAWA, Kanagawa (JP); AYUMI YAMAMOTO, Tokyo (JP); HARUO YOSHIDA, Kanagawa (JP); MASAYOSHI OHNO, Tokyo (JP); TAKASHI KUWABARA, Tokyo (JP); SHIHO NISHINO, Tokyo (JP)

(73) Assignee: SONY CORPORATION, Tokyo (JP)

(21) Appl. No.: 13/960,147

(22) Filed: Aug. 6, 2013

(30) Foreign Application Priority Data
Aug. 21, 2012 (JP) 2012-182006

(51) Int. Cl. H04N 5/232

(52) U.S. Cl. CPC H04N 5/23229
USPC 348/231.3

(57) ABSTRACT

A recording control apparatus includes an acquisition unit that acquires media identification information identifying a recording medium, and recording location identification information identifying a recording medium that is a recording location for content, and a recording control unit that causes the content to be recorded to the recording medium in the case where the media identification information matches the recording location identification information.

### BACKGROUND

The present disclosure relates to a recording control apparatus, a recording control method, and a program. More particularly, the present disclosure relates to a recording control apparatus, a recording control method, and a program configured to reliably cause content to be recorded to a desired recording location, for example.

In the related art, in a digital camera or the like that conducts imaging, there exists recording location determination technology that determines, from among multiple installed recording media, a recording location for an acquired image obtained by imaging (see Japanese Unexamined Patent Application Publication No. 2006-33268, for example).

With this recording location determination technology, a recording location for an acquired image is determined from among multiple installed recording media on the basis of whether or not a factor such as the sharpness of the acquired image satisfies a predetermined condition.

For this reason, according to the recording location determination technology, it is possible to respectively record acquired images that satisfy a condition and acquired images that do not satisfy the condition in separate recording media.

### SUMMARY

Although the recording location determination technology of the related art enables acquired images that satisfy a condition and acquired images that do not satisfy the condition to be sorted and respectively recorded in separate recording media, such sorting is not limited to being sorting that the user desires.

The present disclosure has been devised in light of such circumstances, and is configured to cause content to be reliably recorded to a desired recording location.

A recording control apparatus according to an embodiment of the present disclosure includes an acquisition unit that acquires media identification information identifying a recording medium, and recording location identification information identifying a recording medium that is a recording location for content, and a recording control unit that causes the content to be recorded to the recording medium in the case where the media identification information matches the recording location identification information.

A write unit that writes the media identification information already acquired by the acquisition unit to the recording unit as the recording location identification information associated with the content may be additionally provided.

The write unit may write the media identification information already acquired by the acquisition unit to the recording unit as the recording location identification information associated with content selected from among multiple instances of content.

A content acquisition unit that acquires content may be additionally provided, and from among the media identification information already acquired by the acquisition unit, the write unit may write the media identification information specified before the acquisition of the content to the recording unit as the recording location identification information associated with the content acquired from the content acquisition unit.

The content acquisition unit may be an imaging unit that acquires the content by taking an image of a subject.

The acquisition unit may acquire the media identification information from the recording medium in response to the recording medium being connected.

The acquisition unit may be a connection port connectable to the recording medium, and may acquire the media identification information from the recording medium in response to the recording medium being connected to the connection port.

The acquisition unit may also acquire folder identification information identifying a folder that is a recording location for the content from among multiple folders provided in the recording medium, and the recording control unit may cause the content to be recorded to a folder identified by the folder identification information in the case where the media identification information matches the recording location identification information.

The recording control unit may cause the content to be copied and recorded to the recording medium in the case where the media identification information matches the recording location identification information.

The recording control unit may cause the content to be moved and recorded to the recording medium in the case where the media identification information matches the recording location identification information.

A recording control method according to an embodiment of the present disclosure is a recording control method of a recording control apparatus that causes content to be recorded to a recording medium, and includes acquiring media identification information identifying a recording medium, acquiring recording location identification information identifying a recording medium that is a recording location for content, and causing the content to be recorded to the recording medium in the case where the media identification information matches the recording location identification information.

A program according to an embodiment of the present disclosure causes a computer to function as an acquisition control unit that controls the acquisition of media identification information identifying a recording medium, and the acquisition of recording location identification information identifying a recording medium that is a recording location for content, and as a recording control unit that causes the content to be recorded to the recording medium in the case where the media identification information matches the recording location identification information.

According to an embodiment of the present disclosure, media identification information identifying a recording medium is acquired, while in addition, recording location identification information identifying a recording medium that is a recording location for content is also acquired, and the content is recorded to the recording medium in the case where the media identification information matches the recording location identification information.

According to the present disclosure, it becomes possible to reliably record content to a desired recording location.

### BRIEF DESCRIPTION OF THE DRAWINGS

FIG. 1 is a block diagram illustrating an exemplary configuration of a recording control apparatus according to a first embodiment;

FIG. 2 is a flowchart for explaining a recording control process conducted by a recording control apparatus;

FIG. 3 is a block diagram illustrating an exemplary configuration of an imaging apparatus according to a second embodiment;

FIG. 4 is a first diagram illustrating an example of a display screen on a display unit;

FIG. 5 is a second diagram illustrating an example of a display screen on a display unit;

FIG. 6 is a third diagram illustrating an example of a display screen on a display unit;

FIG. 7 is a fourth diagram illustrating an example of a display screen on a display unit;

FIG. 8 is a fifth diagram illustrating an example of a display screen on a display unit;

FIG. 9 is a flowchart for explaining a recording control process conducted by an imaging apparatus;

FIG. 10 is a flowchart for explaining a first recording location determination process conducted by an imaging apparatus;

FIG. 11 is a sixth diagram illustrating an example of a display screen on a display unit;

FIG. 12 is a seventh diagram illustrating an example of a display screen on a display unit;

FIG. 13 is a flowchart for explaining a second recording location determination process conducted by an imaging apparatus; and

FIG. 14 is a block diagram illustrating an exemplary configuration of a computer.

### DETAILED DESCRIPTION OF EMBODIMENTS

Hereinafter, embodiments for carrying out the present disclosure (hereinafter designated embodiments) will be described. The description will proceed in the following order:

1. First Embodiment (example of recording content to external recording medium)

2. Second Embodiment (example of associating recording location identification information with content)

3. Modifications

### 1. First Embodiment

[Exemplary Configuration of Recording Control Apparatus 1]

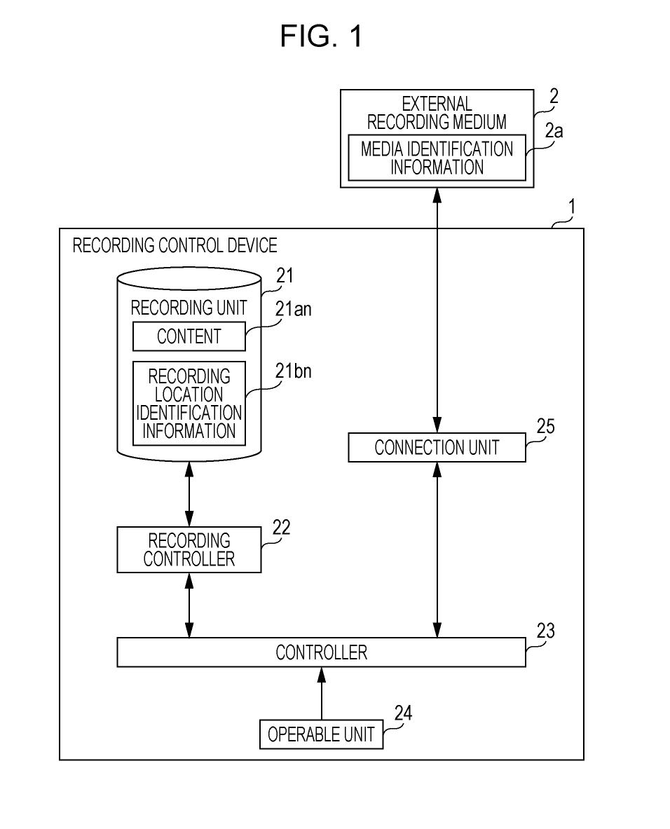

FIG. 1 illustrates an exemplary configuration of a recording control apparatus according to a first embodiment.

Note that in the case where media identification information 2a identifying an external recording medium 2 matches recording location identification information 21bₙ, identifying the recording location of recorded content 21aₙ, in a recording unit 21, the recording control apparatus 1 causes the content 21aₙ to be recorded in the external recording medium 2.

Herein, media such as an external hard disk, a memory card, or USB memory, for example, may be adopted as the external recording medium 2.

The recording control apparatus 1 is a device such as a tablet or personal computer, for example, and includes a recording unit 21, a recording controller 22, a controller 23, an operable unit 24, and a connection unit 25.

The recording unit 21 is non-volatile memory such as electrically erasable programmable read-only memory (EEPROM), for example. The recording unit 21 records content 21aₙ, which may be information such as a still image, a moving image, music, audio data, document data, or graphical data, for example, and also records recording location identification information 21bₙ associated with the content 21aₙ. Note that n is taken to be n=1, 2, . . . , N.

Also, the content 21aₙ and the recording location identification information 21bₙ is managed with a list in the recording unit 21, for example.

The recording controller 22, under control by the controller 23, retrieves content 21aₙ and recording location identification information 21bₙ from the recording unit 21, and supplies the retrieved information to the controller 23.

The recording controller 22 also records (writes) content 21aₙ and recording location identification information 21bₙ from the controller 23 to the recording unit 21. Note that the content 21aₙ and the recording location identification information 21bₙ is supplied to the recording controller 22 via the connection unit 25 and the controller 23 from an external recording medium on which content 21aₙ and recording location identification information 21bₙ is recorded, for example.

Herein, although the recording control apparatus 1 is configured to include the recording unit 21 as illustrated in FIG. 1, the recording control apparatus 1 may also be configured to not include the recording unit 21. In this case, the recording controller 22 of the recording control apparatus 1 conducts operations such as retrieving content 21aₙ from a recording unit 21 provided externally to the recording control apparatus 1.

The controller 23 determines whether or not media identification information 2a supplied from the connection unit 25 matches recording location identification information 21bₙ supplied from the recording controller 22, for example.

Then, in the case of determining that the media identification information 2a of the external recording medium 2 matches the recording location identification information 21bₙ, the controller 23 controls the recording controller 22 and the connection unit 25 to cause content 21aₙ recorded in the recording unit 21 to be recorded to the external recording medium 2.

The operable unit 24 includes elements such as operable buttons operated by the user, and in response to being operated by the user, supplies the controller 23 with an operation signal corresponding to the user operation. Note that the operable unit 24 may be provided externally to the recording control apparatus 1 as a remote control or the like, for example.

As another example, a user may be able to use the operable unit 24 to conduct an operation for setting a method of recording content 21aₙ to the external recording medium 2.

Thus, on the basis of an operation signal from the operable unit 24, the controller 23 determines a recording method set by the user, and causes content 21aₙ to be recorded to the external recording medium 2 by the determined recording method.

Herein, potential recording methods include, for example, a first recording method that moves content 21aₙ from the recording unit 21 to the external recording medium 2, and a second recording method that copies content 21aₙ recorded in the recording unit 21 to the external recording medium 2.

Consequently, according to the first recording method, in the case of determining that the media identification information 2a of the external recording medium 2 matches the recording location identification information 21bₙ, the controller 23 is able to move content 21aₙ recorded in the recording unit 21 to the external recording medium 2.

As another example, according to the second recording method, in the case of determining that the media identification information 2a of the external recording medium 2 matches the recording location identification information 21bₙ, the controller 23 is able to copy content 21aₙ recorded in the recording unit 21 to the external recording medium 2.

The connection unit 25 includes receptacles (connection ports) or the like which enable connection by accepting the insertion of the external recording medium 2, for example. The external recording medium 2 is physically connected to the connection unit 25. Note that the external recording medium 2 may be Universal Serial Bus (USB) memory or a memory card inserted directly into the connection unit 25, but may also be a device such as an external hard disk inserted into the connection unit 25 via a cable or the like.

The connection unit 25, under control by the controller 23, acquires media identification information 2a of the external recording medium 2 by retrieval from the external recording medium 2 connected to the connection unit 25, and supplies the acquired media identification information 2a to the controller 23.

As another example, the connection unit 25, under control by the controller 23, records (writes) content 21aₙ from the controller 23 to the external recording medium 2.

Note that besides the external recording medium 2, a communication apparatus or the like able to wirelessly communicate with the connection unit 25 may also be connected to the connection unit 25.

In this case, in response to being connected to a communication apparatus by wireless communication, the connection unit 25 retrieves, from an internal recording medium housed inside the communication apparatus, media identification information identifying that internal recording medium, or alternatively, writes content 21aₙ to the internal recording medium.

Herein, technology such as near field communication (NFC), TransferJet (registered trademark), Bluetooth (registered trademark), Wi-Fi (registered trademark), 3G, or long-term evolution (LTE) (registered trademark), for example, may be implemented as the wireless communication conducted between the connection unit 25 and a communication apparatus. The connection unit 25 may also communicate as a result of being connected to a communication apparatus via a cable or the like.

Furthermore, a server on a network such as the Internet (a server that provides a social networking service (SNS), homepage, or the like, for example) may also be connected to the connection unit 25, for example.

In this case, in response to being connected to a server, the connection unit 25 retrieves, from an internal recording medium housed inside the server, media identification information identifying that internal recording medium, or alternatively, writes content 21aₙ to the internal recording medium.

Note that in the first embodiment, the connection unit 25 acquires media identification information 2a by retrieval from the external recording medium 2, and the recording controller 22 acquires recording location identification information 21bₙ by retrieval from the recording unit 21.

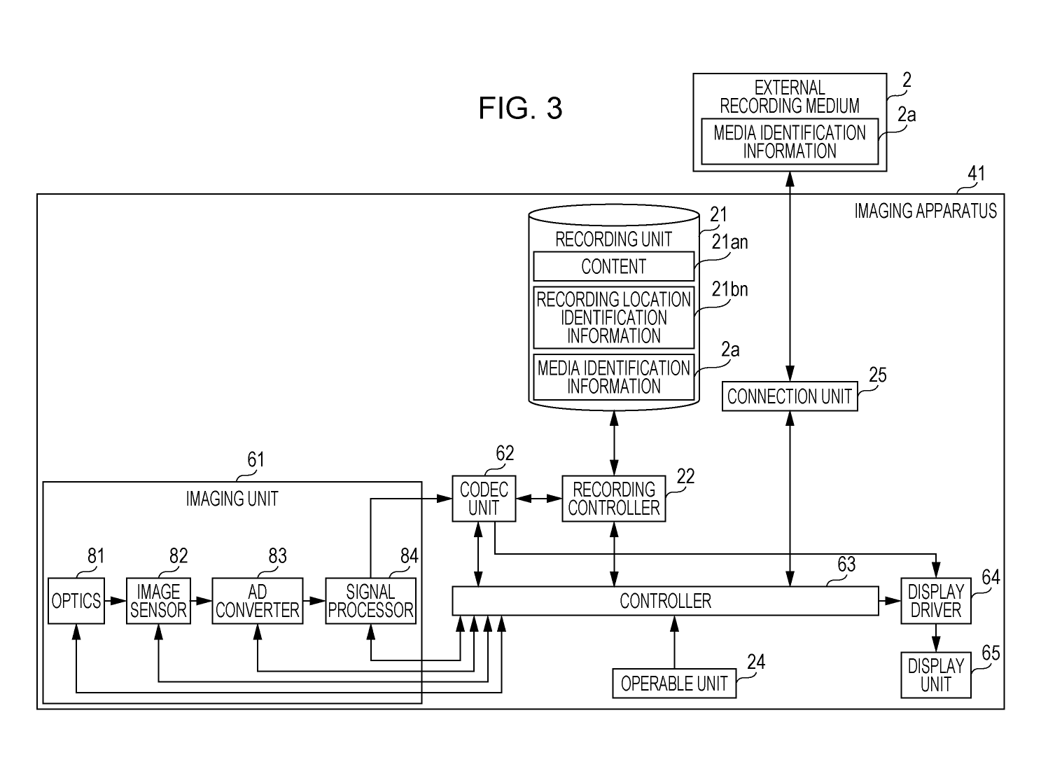

However, the recording control apparatus 1 in FIG. 1 may also be provided with an acquisition unit that respectively acquires media identification information 2a from the external recording medium 2 and recording location identification information 21bₙ from the recording unit 21, and supplies the acquired information to the controller 23. This configuration similarly applies to the imaging apparatus 41 in FIG. 3.

In this case, the acquisition of recording location identification information 21bₙ by the recording controller 22 as well as the acquisition of media identification information 2a by the connection unit 25 are not conducted, and the acquisition unit exclusively conducts the acquisition of recording location identification information 21bₙ as well as the acquisition of media identification information 2a.

The controller 23 then determines whether or not media identification information 2a supplied from the acquisition unit matches recording location identification information 21bₙ supplied from the same acquisition unit.

In the case of determining that the media identification information 2a matches the recording location identification information 21bₙ, the controller 23 controls the recording controller 22 and the connection unit 25 to cause content 21aₙ recorded in the recording unit 21 to be recorded to the external recording medium 2.

[Behavior of Recording Control Apparatus 1]

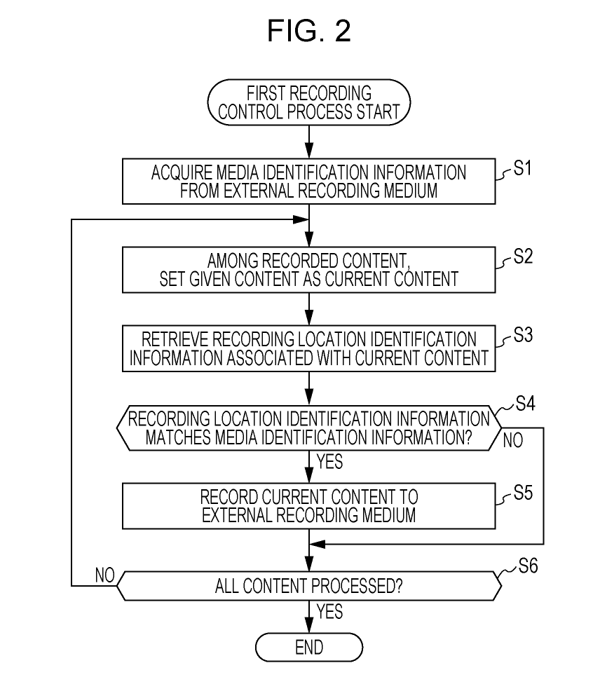

Next, a recording control process (hereinafter designated the first recording control process) conducted by the recording control apparatus 1 will be described with reference to the flowchart in FIG. 2.

The first recording control process is started when an external recording medium 2 is connected to the connection unit 25, for example.

At this time, in step S1 the connection unit 25 acquires media identification information 2a by retrieval from the connected external recording medium 2, and supplies the acquired media identification information 2a to the controller 23.

In step S2, the controller 23 selects given content 21aₙ to process (hereinafter designated the current content 21aₙ) from among the content 21aₙ to 21aₙ recorded in the recording unit 21.

In step S3, the recording controller 22, under control by the controller 23, retrieves recording location identification information 21bₙ associated with the current content 21aₙ from the recording unit 21, and supplies the retrieved recording location identification information 21bₙ to the controller 23.

In step S4, the controller 23 determines whether or not the recording location identification information 21bₙ from the recording controller 22 matches the media identification information 2a from the connection unit 25, and proceeds to step S5 in the case of determining a match.

In step S5, the controller 23 controls the recording controller 22 and the connection unit 25 to cause the current content 21aₙ recorded in the recording unit 21 to be recorded to the external recording medium 2 connected to the connection unit 25.

In other words, the recording controller 22, under control by the controller 23, retrieves the current content 21aₙ from the recording unit 21, and supplies the retrieved current content 21aₙ to the controller 23, for example.

The controller 23 supplies the current content 21aₙ from the recording controller 22 to the connection unit 25. The connection unit 25, under control by the controller 23, records the current content 21aₙ from the controller 23 to the external recording medium 2.

Meanwhile, in the case of determining in step S4 that the recording location identification information 21bₙ from the recording controller 22 does not match the media identification information 2a from the connection unit 25, the controller 23 skips the processing in step S5, and proceeds to step S6.

In step S6, the controller 23 determines whether or not all of the content 21a₁ to 21a_{N} recorded in the recording unit 21 has been selected as the current content, and returns to step S2 in the case of determining that not all of the content 21ₐ₁ to 21a_{N} has been selected yet as the current content.

Then, in step S2, from among the content 21a₁ to 21a_{N} recorded in the recording unit 21, the controller 23 selects content 21aₙ₊₁ that has not been selected yet as the current content, proceeds to step S3 taking the selected content as the new current content 21aₙ₊₁, and thereafter conducts similar processing.

Meanwhile, in the case of determining in step S6 that all of the content 21a₁ to 21a_{N} recorded in the recording unit 21 has been selected as the current content, the controller 23 ends the first recording control process.

As described above, according to the first recording control process, the controller 23 determines whether or not the media identification information 2a of the external recording medium 2 matches recording location identification information 21bₙ associated with the current content 21aₙ.

Then, in the case of determining that the media identification information 2a matches the recording location identification information 21bₙ, the controller 23 causes the current content 21aₙ recorded in the recording unit 21 to be recorded to the external recording medium 2.

Thus, simply connecting the external recording medium 2 to the recording control apparatus 1 enables the recording of user-desired content 21aₙ to the external recording medium 2 from among multiple content 21a₁ to 21a_{N} recorded in the recording unit 21.

Furthermore, the controller 23 becomes able to easily identify the recording location of the current content 21aₙ on the basis of whether or not the media identification information 2a matches the recording location identification information 21bₙ.

Also, according to the first recording control process, simply connecting the external recording medium 2 to the recording control apparatus 1 enables content 21aₙ in the recording unit 21 to be recorded to the external recording medium 2, for example.

For this reason, by simply connecting an external recording medium 2′ received from a person A to the connection unit 25, a user is able to reliably record content 21aₙ that the user wants to distribute to the person A to the external recording medium 2′.

Note that this case assumes that recording location identification information 21bₙ matching media identification information 2a′ of the external recording medium 2′ is associated with the content 21aₙ that the user wants to distribute to the person A.

### 2. Second Embodiment

[Exemplary Configuration of Imaging Apparatus 41]

Next, FIG. 3 illustrates an exemplary configuration of an imaging apparatus 41 according to a second embodiment.

The imaging apparatus 41 differs from the recording control apparatus 1 in that the imaging apparatus 41 takes images of subjects, treats acquired images obtained by imaging as content 21aₙ, and records recording location identification information 21bₙ associated with the content 21aₙ to the recording unit 21. Otherwise, the imaging apparatus 41 is similar to the recording control apparatus 1.

In addition, although a digital camera or smartphone may be adopted as the imaging apparatus 41, for example, the imaging apparatus 41 may be any apparatus including an imaging unit that takes images of subjects.

Note that in the imaging apparatus 41 in FIG. 3, portions configured similarly to the recording control apparatus 1 in FIG. 1 are denoted with the same reference signs, and the description of such portions may be reduced or omitted hereinafter.

Namely, the imaging apparatus 41 is newly provided with an imaging unit 61, a codec unit 62, a display driver 64, and a display unit 65, and is additionally provided with a controller 63 instead of the controller 23 in FIG. 1. Otherwise, the configuration is similar to the recording control apparatus 1 in FIG. 1.

Also, in FIG. 3, besides the content 21aₙ and the recording location identification information 21bₙ, the media identification information 2a of the external recording medium 2 connected to the connection unit 25 is also recorded in the recording unit 21.

The imaging unit 61 takes an image of a subject, and supplies an acquired image obtained by such imaging to the codec unit 62.

In other words, the imaging unit 61 includes optics 81, an image sensor 82, an analog-to-digital (AD) converter 83, and a signal processor 84, for example.

The optics 81 include components such as one or more optical lenses, a focusing mechanism, a shutter mechanism, and a diaphragm (iris) mechanism. The optics 81 condenses light incident when taking an image of a subject (reflected light from the subject, for example). In other words, the optics 81 cause the light incident when taking an image of a subject to form an image on the light-sensing face of the image sensor 82.

The image sensor 82 conducts photoelectric conversion that converts incident light incident via the optics 81 into an image signal, and supplies the image signal obtained by such photoelectric conversion to the AD converter 83. Note that an image sensor such as a charge-coupled device (CCD) image sensor or a complementary metal-oxide-semiconductor (CMOS) image sensor may be implemented as the image sensor 82, for example.

The AD converter 83 converts an analog image signal supplied from the image sensor 82 into a digital image signal obtained by AD conversion, and supplies the resulting digital image signal to the signal processor 84.

The signal processor 84 processes the image signal from the AD converter 83, such as removing noise, for example, and supplies the acquired image obtained as a result of such signal processing to the codec unit 62.

Note that although the second embodiment describes an imaging apparatus 41 that acquires an image as content 21aₙ by having an imaging unit 61 take an image of a subject, the present technology may also be applied to an apparatus that acquires content 21aₙ by some other acquisition method.

In other words, present technology may be applied to devices such as a television receiver that acquires content 21aₙ by receiving content 21aₙ broadcast as a program, for example.

Besides the above, the present technology may also be applied to apparatus that acquire content 21aₙ from a network such as the Internet, or an external recording medium, for example.

The codec unit 62, under control by the controller 63, compresses an acquired image from the imaging unit 61 on the basis of a format such as the Moving Picture Experts Group (MPEG), for example, and supplies the compressed acquired image to the recording controller 22. In this case, the recording controller 22 records the compressed acquired image from the codec unit 62 to the recording unit 21 as content 21aₙ.

As another example, the codec unit 62 decompresses a compressed acquired image supplied from the recording controller 22 on the basis of a format such as MPEG, and supplies the decompressed acquired image to the display driver 64.

The controller 63 controls the recording controller 22, the connection unit 25, the imaging unit 61 (the optics 81, the image sensor 82, the AD converter 83, and the signal processor 84), the codec unit 62, and the display driver 64.

Also, the controller 63 conducts similar processing as the controller 23 in FIG. 1 by controlling the recording controller 22 and the connection unit 25, for example.

Note that the controller 63 may also control the codec unit 62 such that an acquired image supplied from the imaging unit 61 to the codec unit 62 is supplied directly to the recording controller 22 without being compressed. In this case, the recording controller 22, under control by the controller 63, records an uncompressed acquired image supplied from the codec unit 62 to the recording unit 21 as content 21aₙ.

Additionally, the controller 63 determines whether or not media identification information 2a supplied from the connection unit 25 is recorded already in the recording unit 21.

In the case of determining that the media identification information 2a supplied from the connection unit 25 is recorded already in the recording unit 21, the controller 63 supplies the media identification information 2a of the external recording medium 2 to the recording controller 22. The controller 63 then controls the recording controller 22 to record the media identification information 2a in the recording unit 21.

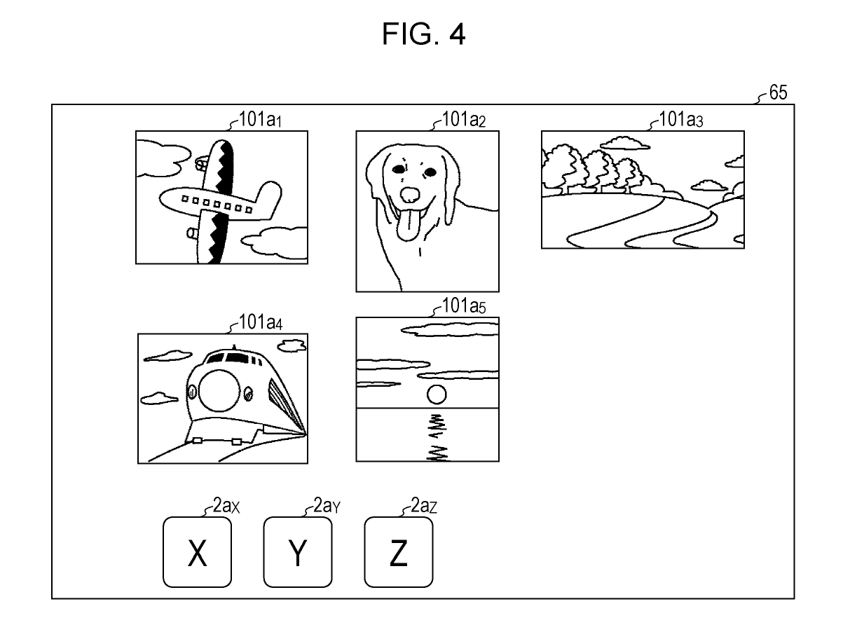

Also, on the basis of an operation signal from the operable unit 24, the controller 63 associates, as recording location identification information 21bₙ, any of the media identification information 2a recorded in the recording unit 21 with content 21aₙ likewise recorded in the recording unit 21. The controller 63 then supplies recording location identification information 21bₙ associated with content 21aₙ to the recording controller 22. Details will be discussed later with reference to FIGS. 4 to 10.

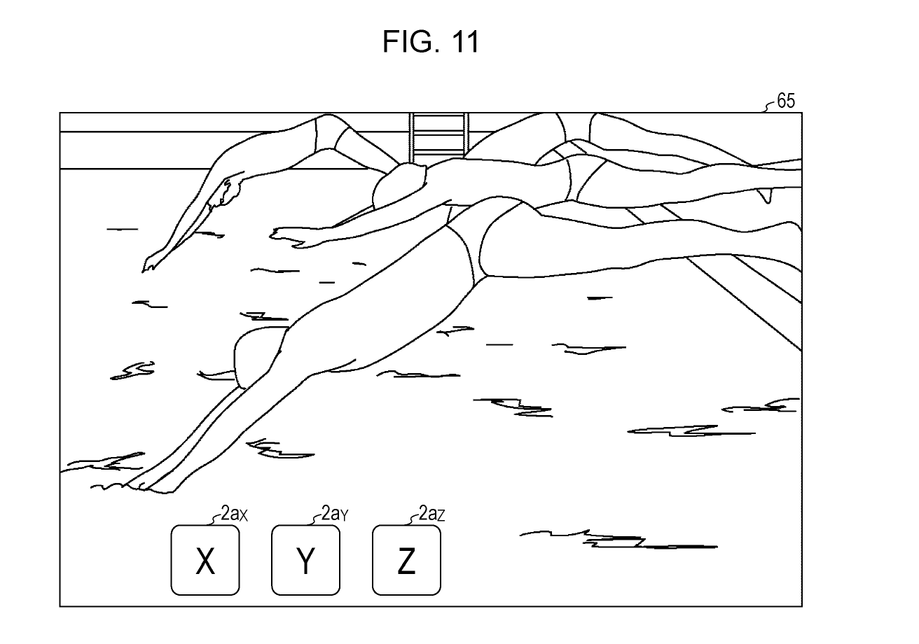

Furthermore, the controller 63 associates, as recording location identification information 21bₙ, predetermined media identification information with content 21aₙ in the form of an acquired image output from the imaging unit 61, and supplies recording location identification information 21bₙ associated with content 21aₙ to the recording controller 22. Details will be discussed later with reference to FIGS. 11 to 13.

Note that the recording controller 22 records recording location identification information 21bₙ from the controller 63 to the recording unit 21.

In the case of determining that media identification information 2a from the connection unit 25 is recorded already in the recording unit 21, the controller 63 conducts similar processing as the controller 23 in FIG. 1.

In other words, the controller 63 determines whether or not media identification information 2a from the connection unit 25 matches recording location identification information 21bₙ from the recording controller 22, for example.

Then, in the case of determining that the media identification information 2a from the connection unit 25 matches the recording location identification information 21bₙ from the recording controller 22, the controller 63 controls the recording controller 22 and the connection unit 25 to record content 21aₙ to the external recording medium 2.

Note that in the case where the content 21aₙ is a compressed acquired image, the controller 63 may also control the codec unit 62 to decompress the compressed acquired image before being recorded to the external recording medium 2.

Furthermore, the controller 63 generates display data for displaying content displays representing the content 21aₙ as well as media displays representing the media identification information 2a, and supplies the generated display data to the display driver 64.

Note that the controller 63 generates display data on the basis of information such as content 21aₙ and media identification information 2a recorded in the recording unit 21, and an operation signal from the operable unit 24.

The display driver 64 causes the display unit 65 to display a content display and a media display, for example, on the basis of display data from the controller 63. The display driver 64 also causes the display unit 65 to display an acquired image from the codec unit 62.

The display unit 65 is a device such as a liquid crystal display (LCD), for example. The display unit 65, under control by the display driver 64, displays information such as a content display and a media display, in addition to an acquired image. Note that display screens on the display unit 65 will be discussed later with reference to FIGS. 4 to 8.

Next, FIG. 4 illustrates an example of a display screen on the display unit 65.

Namely, on the display screen in FIG. 4, content displays 101a₁ to 101a₅ are displayed, and in addition, media displays 2aₓ to 2a_{z} are displayed below the content displays 101a₁ to 101a₅.

Herein, the content displays 101a₁ to 101a₅ refer to displays that respectively represent content 21a₁ to 21a₅ recorded in the recording unit 21. For example, in the case where the content 21a₁ to 21a₅ are still images, thumbnails, which are reduced images of the still images, are displayed as the content displays 101a₁ to 101a₅.

Also, the media displays 2aₓ to 2a_{z} refer to displays that respectively represent media identification information 2a recorded in the recording unit 21. In other words, the media display 2aₓ represents media identification information X, the media display 2a_{y} represents media identification information Y, and the media display 2a_{z} represents media identification information Z.

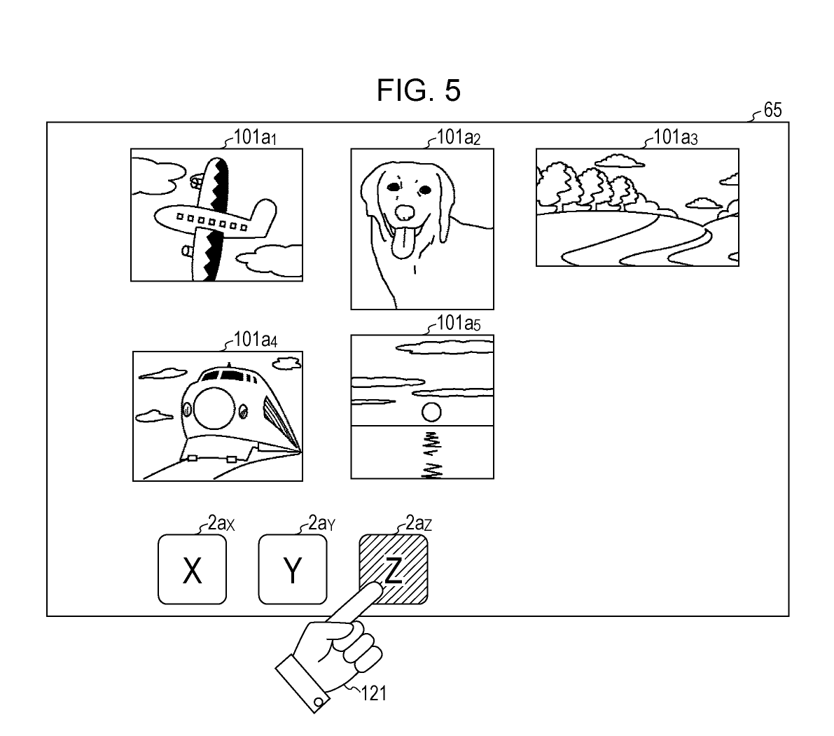

Note that although five content displays 101a₁ to 101a₅ and three media displays 2aₓ to 2a_{z} are displayed in the example in FIG. 4, the number and layout of content displays and media displays is not limited thereto. This applies similarly to FIGS. 5 to 8, FIG. 11, and FIG. 12.

A user uses the operable unit 24 while referring to the display screen on the display unit 65 illustrated in FIG. 4, and performs an operation causing recording location identification information 21bₙ to be associated with content 21aₙ and recorded in the recording unit 21.

Next, an example of how media identification information Z is associated with content 21a₃ represented by a content display 101a₃ as recording location identification information 21b₃ will be described with reference to FIGS. 5 to 7.

Note that in the following, user operations are described as being performed on the operable unit 24. However, in the case where the display unit 65 is configured as a touch panel operable by an instrument such as a user's fingers, for example, the user is able to perform operations on the display unit 65.

The user uses the operable unit 24 to move a pointer 121 over the media display 2a_{z}, and performs a specifying operation that specifies the media display 2a_{z}, as illustrated in FIG. 5.

Thus, the media display 2a_{z} is displayed in distinction from the other media displays 2aₓ and 2a_{y}, as illustrated in FIG. 5. Namely, in FIG. 5, the media display 2a_{z} is highlighted with added shading, in distinction from the other media displays 2aₓ and 2a_{y}.

Note that although FIG. 5 illustrates a method of displaying the media display 2a_{z} with added shading as the method of highlighting the media display 2a_{z}, the method of highlighting the media display 2a_{z} is not limited thereto. In other words, it is possible to implement a method that highlights the media display 2a_{z} with an inverted display (in the media display 2a_{z}, displaying Z with a white color, and displaying everything other than Z with a black color), for example.

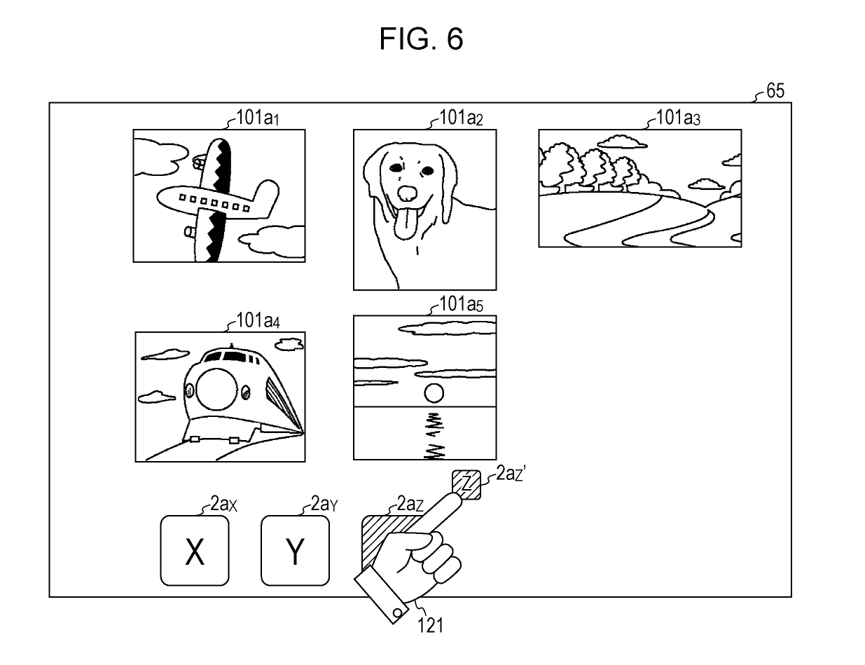

The user also uses the operable unit 24 to perform a drag operation that moves the pointer 121 while in a state of specifying the media display 2a_{z}. Thus, the pointer 121 moves together with a reduced media display 2a_{z}′ in which the media display 2a_{z} is reduced, as illustrated in FIG. 6.

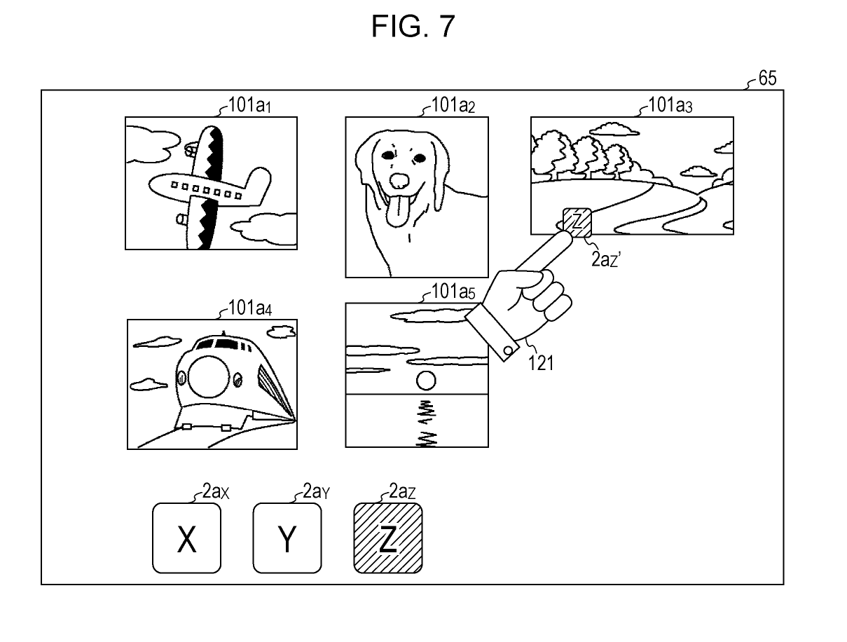

Then, after moving the reduced media display 2a_{z}′ over the content display 101a₃ with the drag operation, the user performs a drop operation that releases the specification of the media display 2a_{z} over the content display 101a₃. Thus, the reduced media display 2a_{z}′ is added to the content display 101a₃, as illustrated in FIG. 7.

At this point, the controller 63, on the basis of an operation signal from the operable unit 24, associates the media identification information Z represented by the media display 2a_{z} with the content 21a₃ represented by the content display 101a₃ as recording location identification information 21b₃.

The controller 63 then supplies the media identification information Z associated with the content 21a₃, namely the recording location identification information 21b₃, to the recording controller 22. The recording controller 22, under control by the controller 63, records the recording location identification information 21b₃ from the controller 63 to the recording unit 21.

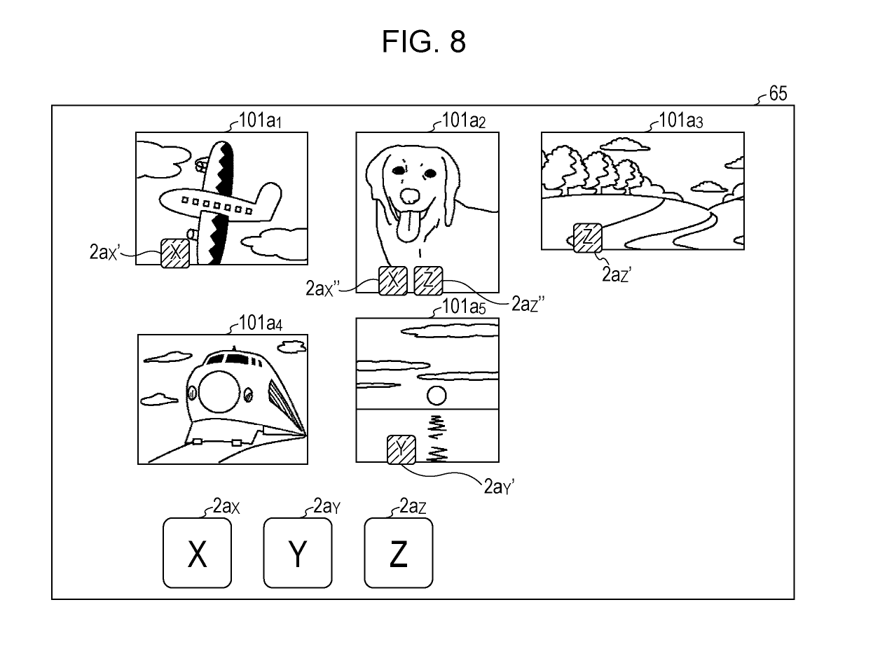

Note that in FIG. 8, reduced media displays 2aₓ′ and 2a_{y}′ have been added to the content displays 101a₁ and 101a₅, respectively, in addition to the reduced media display 2a_{z}′ being added to the content display 101a₃.

Also, besides one instance of media identification information, multiple instances of media identification information may be associated with content 21aₙ as recording location identification information 21bₙ.

In other words, the user uses the operable unit 24 to perform operations that add reduced media displays 2aₓ″ and 2a_{z}″ to the content display 101a₂, as illustrated in FIG. 8, for example.

At this point, the controller 63, on the basis of an operation signal from the operable unit 24, associates the media identification information X represented by the media display 2aₓ″ and the media identification information Z represented by the media display 2a_{z}″ with the content 21a₂ represented by the content display 101a₂ as recording location identification information 21b₂.

The controller 63 then supplies the recording controller 22 with the recording location identification information 21b₂ respectively expressing the media identification information X and Z associated with the content 21a₂. The recording controller 22, under control by the controller 63, records the recording location identification information 21b₂ from the controller 63 to the recording unit 21.

[Behavior of Imaging Apparatus 41]

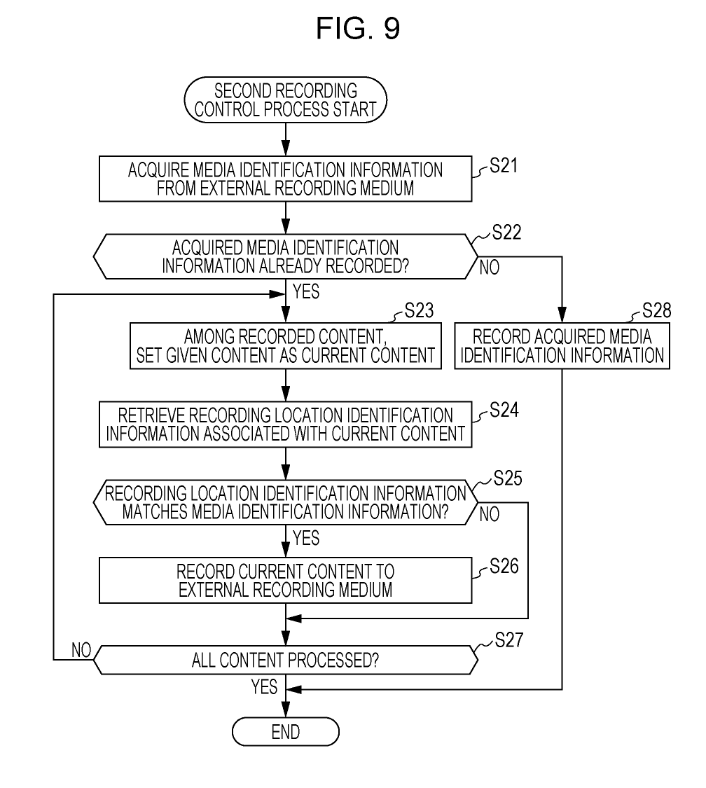

Next, a recording control process (hereinafter designated the second recording control process) conducted by the imaging apparatus 41 will be described with reference to the flowchart in FIG. 9.

The second recording control process is started when an external recording medium 2 is connected to the connection unit 25, for example.

At this time, in step S21, processing similar to step S1 of FIG. 2 is conducted. In other words, the connection unit 25 acquires media identification information 2a by retrieval from the connected external recording medium 2, and supplies the acquired media identification information 2a to the controller 63.

In step S22, the controller 63 determines whether or not the media identification information 2a from the connection unit 25 is recorded already in the recording unit 21, and proceeds to step S23 in the case of determining that the media identification information 2a is recorded already in the recording unit 21.

From step S23 to step S27, the controller 63 conducts similar processing as the controller 23 in FIG. 1. In other words, from step S23 to step S27, processing similar to step S2 to step S6 of FIG. 2 is conducted.

Meanwhile, the controller 63 proceeds to step S28 in the case of determining in step S22 that the media identification information 2a from the connection unit 25 is not recorded already in the recording unit 21.

In step S28, the controller 63 supplies the media identification information 2a from the connection unit 25 to the recording controller 22. The recording controller 22 records the media identification information 2a from the controller 63 to the recording unit 21, and the second recording control process ends.

As described above, according to the second recording control process, in step S28 the controller 63 records to the recording unit 21 the media identification information 2a of an external recording medium 2 connected to the connection unit 25.

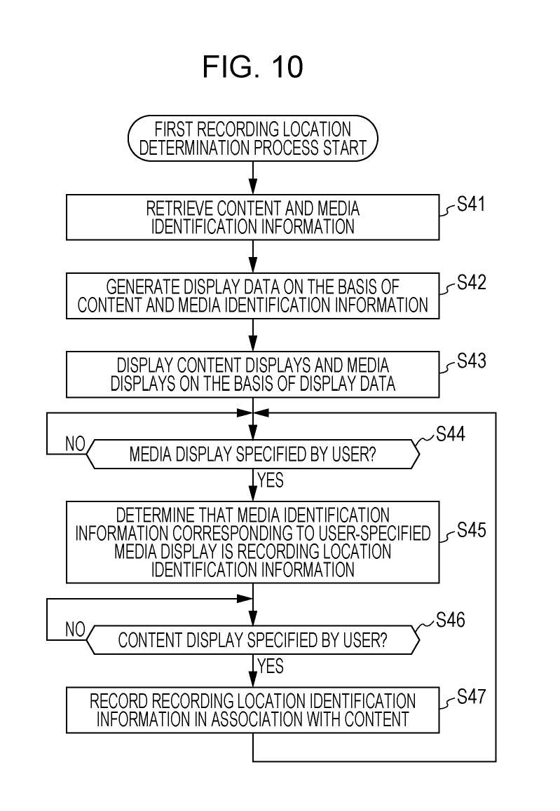

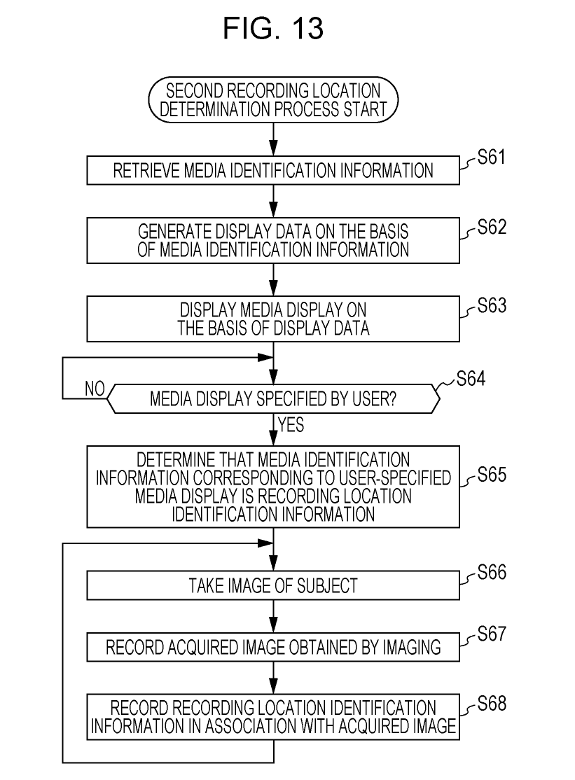

For this reason, the controller 63 is able to associate media identification information 2a recorded in a recording unit 21 with content 21aₙ as recording location identification information 21bₙ. Details will be discussed later with reference to the flowcharts in FIGS. 10 and 13.

Next, a first recording location determination process conducted by the imaging apparatus 41 will be described with reference to the flowchart in FIG. 10.

The first recording location determination process is started when, for example, a user uses the operable unit 24 to perform an operation for displaying a display screen like that illustrated in FIG. 4 on the display unit 65. At this point, the operable unit 24 supplies the controller 63 with an operation signal corresponding to the user's operation.

The controller 63 controls units such as the recording controller 22 and the display driver 64 on the basis of operation signals from the operable unit 24.

In step S41, the recording controller 22, under control by the controller 63, retrieves and supplies the controller 63 with content 21aₙ and media identification information 2a from the recording unit 21. Note that compressed content 21aₙ is first decompressed by the codec unit 62, and then supplied from the recording controller 22 to the controller 63.

In step S42, the controller 63 generates, on the basis of the content 21aₙ and the media identification information 2a from the recording controller 22, display data for respectively displaying a content display representing the content 21aₙ as well as a media display expressing the media identification information 2a, and supplies the generated display data to the display driver 64.

In step S43, the display driver 64 causes the display unit 65 to display a display screen like that illustrated in FIG. 4, for example, on the basis of the display data from the controller 63.

In step S44, the controller 63 determines, on the basis of an operation signal from the operable unit 24, whether or not the user has performed a specifying operation that specifies any of the media displays 2aₓ to 2a_{z} being displayed on the display screen of the display unit 65. The controller 63 then repeats the processing in step S44 until determining, on the basis of an operation signal from the operable unit 24, that the user has performed a specifying operation.

The controller 63 proceeds to step S45 in the case of determining, on the basis of an operation signal from the operable unit 24, that the user has performed a specifying operation.

In step S45, if for example the controller 63 determines that a specifying operation specifying the media display 2a_{z} has been performed as illustrated in FIG. 5, the controller 63 determines the media identification information Z corresponding to the media display 2a_{z} to be recording location identification information 21bₙ.

In step S46, the controller 63 determines, on the basis of an operation signal from the operable unit 24, whether or not the user has performed a selecting operation that selects any of the content displays 101a₁ to 101a₅ being displayed on the display screen of the display unit 65. The controller 63 then repeats the processing in step S46 until determining, on the basis of an operation signal from the operable unit 24, that the user has performed a selecting operation.

The controller 63 proceeds to step S47 in the case of determining, on the basis of an operation signal from the operable unit 24, that a selecting operation selecting the content display 101a₃ has been performed as illustrated in FIGS. 6 and 7, for example.

In step S47, the controller 63 associates the media identification information Z determined to be the recording location identification information 21b₃ with the content 21a₃ represented by the content display 101a₃ selected with the user's selecting operation.

The controller 63 then supplies the recording location identification information 21b₃ associated with the content 21a₃ to the recording controller 22. The recording controller 22 records the recording location identification information 21b₃ from the controller 63 to the recording unit 21, and returns to step S44. Similar processing is conducted in step S44 and thereafter, and by repeating the processing from step S44 to step S47, the display screen on the display unit 65 becomes a display screen like that illustrated in FIG. 8, for example.

Note that the first recording location determination process ends when, for example, the user uses the operable unit 24 to perform an operation for ending the display of a display screen like that illustrated in FIGS. 4 to 8.

As described above, according to the first recording location determination process, in response to user operations, recording location identification information 21bₙ that identifies one or more recording locations for content 21aₙ is recorded to the recording unit 21 in association with the content 21aₙ.

For this reason, according to the first recording location determination process, it is possible for a user to set the recording location for content 21aₙ recorded in the recording unit 21 to a desired external recording medium 2.

Note that in the second embodiment, recording location identification information 21bₙ is associated with content 21aₙ already recorded in the recording unit 21 in response to user operations, as illustrated in FIGS. 4 to 8. However, the method of associating content 21aₙ and recording location identification information 21bₙ is not limited thereto.

In other words, the controller 63 may predetermine recording location identification information 21bₙ to associate with content 21aₙ in the form of an acquired image output from the imaging unit 61, for example.

Next, FIG. 11 illustrates an example of a display screen on the display unit 65 when displaying media identification information 2a.

Namely, media displays 2aₓ to 2a_{z} are displayed on the display screen in FIG. 11, and background by a through-the-lens image for the purpose of composition when taking an image, for example.

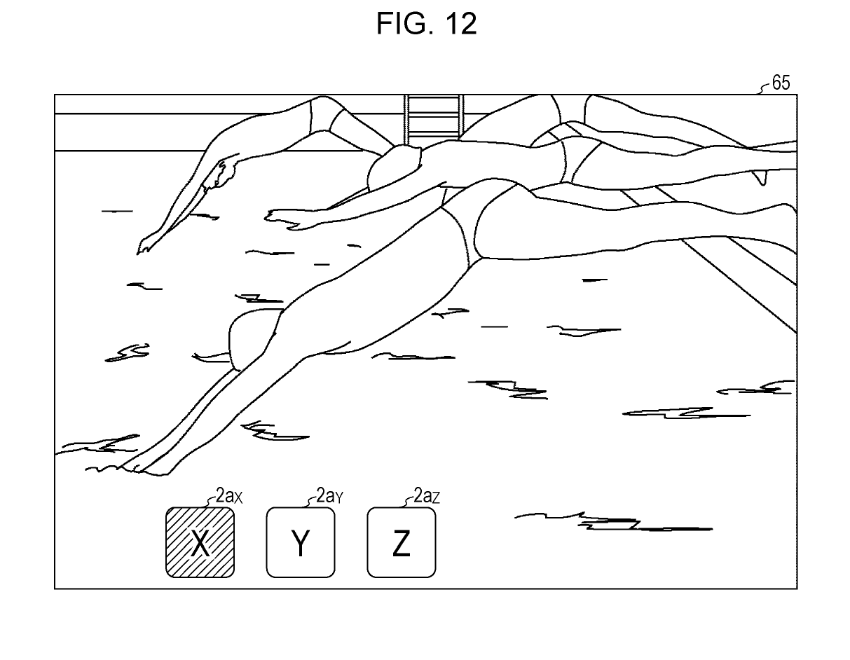

Next, FIG. 12 illustrates an example of a display screen when the media display 2aₓ is specified by a user's specifying operation.

The user uses the operable unit 24 to perform a specifying operation that specifies the media display 2aₓ.

Thus, the media display 2aₓ is displayed in distinction from the other media displays 2a_{y} and 2a_{z}, as illustrated in FIG. 12. Namely, in FIG. 12, the media display 2aₓ is highlighted with added shading, in distinction from the other media displays 2a_{y} and 2a_{z}.

Note that although FIG. 12 illustrates a method of displaying the media display 2aₓ with added shading as the method of highlighting the media display 2aₓ, the method of highlighting the media display 2aₓ is not limited thereto. In other words, it is possible to implement a method that highlights the media display 2aₓ with an inverted display (in the media display 2aₓ, displaying X with a white color, and displaying everything other than X with a black color), for example.

On the basis of an operation signal from the operable unit 24, the controller 63 determines the media identification information X represented by the media display 2aₓ to be recording location identification information 21bₙ. The controller 63 then associates the determined recording location identification information 21bₙ with content 21aₙ in the form of an acquired image output from the imaging unit 61, and supplies the associated recording location identification information 21bₙ to the recording controller 22.

The recording controller 22 records the recording location identification information 21bₙ from the controller 63 to the recording unit 21.

Next, a second recording location determination process conducted by the imaging apparatus 41 will be described with reference to the flowchart in FIG. 13.

The second recording location determination process is started when, for example, a user uses the operable unit 24 to perform an operation for displaying a display screen like that illustrated in FIG. 11 on the display unit 65. At this point, the operable unit 24 supplies the controller 63 with an operation signal corresponding to the user's operation.

The controller 63 controls units such as the recording controller 22 and the display driver 64 on the basis of operation signals from the operable unit 24.

In step S61, the recording controller 22 retrieves and supplies the controller 63 with media identification information 2a from the recording unit 21, such as media identification information X, Y, and Z, for example.

In step S62, the controller 63 generates, on the basis of media identification information 2a from the recording controller 22, display data for displaying media displays expressed by the media identification information 2a, and supplies the generated display data to the display driver 64.

In step S63, the display driver 62 causes the display unit 65 to display a display screen displaying the media displays 2aₓ to 2a_{z} like that illustrated in FIG. 11, for example, on the basis of the display data from the controller 63.

In step S64, the controller 63 determines, on the basis of an operation signal from the operable unit 24, whether or not the user has performed a specifying operation that specifies any of the media displays 2aₓ to 2a_{z} being displayed on the display screen of the display unit 65. The controller 63 then repeats the processing in step S64 until determining, on the basis of an operation signal from the operable unit 24, that the user has performed a specifying operation.

The controller 63 proceeds to step S65 in the case of determining, on the basis of an operation signal from the operable unit 24, that the user has performed a specifying operation.

In step S65, if for example a user's specifying operation specifies the media display 2aₓ, the controller 63 determines the media identification information X corresponding to the media display 2aₓ to be recording location identification information 21bₙ. Then, on the basis of an operation signal corresponding to the user's specifying operation supplied from the operable unit 24, the controller 63 generates display data for displaying a display screen like that illustrated in FIG. 12, and supplies the generated display data to the display driver 64. The display driver 64 causes the display unit 65 to display a display screen like that illustrated in FIG. 12, on the basis of the display data from the controller 63.

Meanwhile, the controller 63 proceeds to step S66 when determining, on the basis of an operation signal from the operable unit 24, that an operation for starting imaging by the imaging unit 61 has been performed.

In step S66, the imaging unit 61 takes an image of a subject, and supplies an acquired image obtained by such imaging to the codec unit 62 as content 21aₙ.

In step S67, the codec unit 62 compresses the content 21aₙ from the imaging unit 61, and supplies the compressed content 21aₙ to the recording controller 22. The recording controller 22 records the content 21aₙ from the codec unit 62 to the recording unit 21.

In step S68, the controller 63 supplies the recording controller 22 with recording location identification information 21bₙ determined in the processing of step S65 in a state of association with the content 21aₙ output from the imaging unit 61.

The recording controller 22 records the recording location identification information 21bₙ from the controller 63 to the recording unit 21, and returns to step S66. Thereafter, similar processing is conducted.

Note that the second recording location determination process ends when, for example, a user uses the operable unit 24 to perform an operation for stopping imaging by the imaging unit 61.

As described above, according to the second recording location determination process, a recording location for an acquired image obtained during imaging is predetermined, thus making it possible to omit the burden of determining a recording location one at a time for each acquired image output from the imaging unit 61.

### 3. Modifications

The first and second embodiments are configured such that the connection unit 25 records content 21aₙ recorded in the recording unit 21 to an external recording medium 2 in the case where media identification information 2a of the external recording medium 2 matches recording location identification information 21bₙ.

However, the medium onto which content 21aₙ is recorded is not limited to an external recording medium 2 connected to the connection unit 25, and an internal recording medium housed inside the recording control apparatus 1 or the imaging apparatus 41 may also be treated as the medium onto which content 21aₙ is recorded, for example.

In this case, media identification information identifying the internal recording medium is recorded in the internal recording medium, similarly to the external recording medium 2.

Also, the first and second embodiments are configured such that media identification information 2a identifying an external recording medium 2 is recorded in the external recording medium 2.

However, besides the media identification information 2a, folder identification information that identifies a folder for recording content 21aₙ from among multiple folders (directories) provided in the external recording medium 2 may also be prerecorded in the external recording medium 2.

In this case, the connection unit 25 acquires media identification information 2a together with folder identification information by retrieval from the external recording medium 2. The connection unit 25 then records content 21aₙ to the folder identified by the acquired folder identification information in the case where the similarly acquired media identification information 2a matches the recording location identification information 21bₙ.

Note that a folder into which to record content 21aₙ may be set by the user of the external recording medium 2, for example, and folder identification information is recorded in the external recording medium 2 according to settings set by the user of the external recording medium 2.

Meanwhile, the present technology may take configurations like the following:

(1) A recording control apparatus including an acquisition unit that acquires media identification information identifying a recording medium, and recording location identification information identifying a recording medium that is a recording location for content, and a recording control unit that causes the content to be recorded to the recording medium in the case where the media identification information matches the recording location identification information.

(2) The recording control apparatus according to (1), additionally including a write unit that writes the media identification information already acquired by the acquisition unit to the recording unit as the recording location identification information associated with the content.

(3) The recording control apparatus according to (2), wherein the write unit writes the media identification information already acquired by the acquisition unit to the recording unit as the recording location identification information associated with content selected from among multiple instances of content.

(4) The recording control apparatus according to (2), additionally including a content acquisition unit that acquires content, wherein, from among the media identification information already acquired by the acquisition unit, the write unit writes the media identification information specified before the acquisition of the content to the recording unit as the recording location identification information associated with the content acquired from the content acquisition unit.

(5) The recording control apparatus according to (4), wherein the content acquisition unit is an imaging unit that acquires the content by taking an image of a subject.

(6) The recording control apparatus according to (1) to (5), wherein the acquisition unit acquires the media identification information from the recording medium in response to the recording medium being connected.

(7) The recording control apparatus according to (6), wherein the acquisition unit is a connection port connectable to the recording medium, and acquires the media identification information from the recording medium in response to the recording medium being connected to the connection port.

(8) The recording control apparatus according to (1) to (7), wherein the acquisition unit also acquires folder identification information identifying a folder that is a recording location for the content from among multiple folders provided in the recording medium, and the recording control unit causes the content to be recorded to a folder identified by the folder identification information in the case where the media identification information matches the recording location identification information.

(9) The recording control apparatus according to (1) to (8), wherein the recording control unit causes the content to be copied and recorded to the recording medium in the case where the media identification information matches the recording location identification information.

(10) The recording control apparatus according to (1) to (8), wherein the recording control unit causes the content to be moved and recorded to the recording medium in the case where the media identification information matches the recording location identification information.

(11) A recording control method of a recording control apparatus that causes content to be recorded to a recording medium, including acquiring media identification information identifying a recording medium, acquiring recording location identification information identifying a recording medium that is a recording location for content, and causing the content to be recorded to the recording medium in the case where the media identification information matches the recording location identification information.

(12) A program causing a computer to function as an acquisition control unit that controls the acquisition of media identification information identifying a recording medium, and the acquisition of recording location identification information identifying a recording medium that is a recording location for content, and as a recording control unit that causes the content to be recorded to the recording medium in the case where the media identification information matches the recording location identification information.

The foregoing series of processes may be executed in hardware, and may also be executed in software, for example. In the case of executing the series of processing operations in software, a program constituting such software may be installed from a program recording medium onto a computer built into special-purpose hardware, or alternatively, onto a computer capable of executing various functions by installing various programs thereon, such as a general-purpose personal computer, for example.

[Exemplary Configuration of Computer]

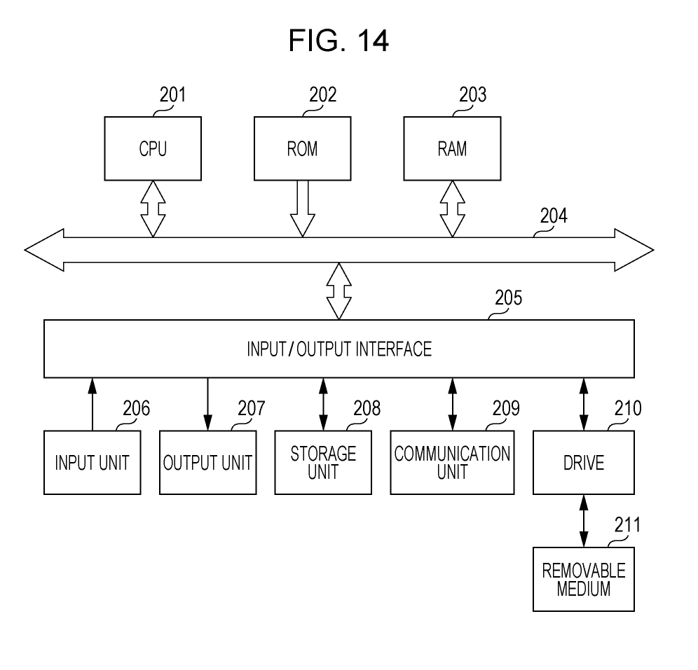

FIG. 14 illustrates an exemplary configuration of a computer that executes the foregoing series of processing operations according to a program.

A CPU 201 executes various processing operations according to a program stored in read-only memory (ROM) 202 or a storage unit 208. Random access memory (RAM) 203 stores information such as programs executed by the CPU 201 and data as appropriate. The CPU 201, ROM 202, and RAM 203 are connected to each other by a bus 204.

Additionally, an input/output interface 205 is connected to the CPU 201 via the bus 204. Connected to the input/output interface 205 are an input unit 206 which includes devices such as a keyboard, mouse, and microphone, and an output unit 207 which includes devices such as a display and one or more speakers. The CPU 201 executes various processing operations in response to commands input from the input unit 206. The CPU 201 then outputs processing results to the output unit 207.

A storage unit 208 connected to the input/output interface 205 includes a hard disk, for example, and stores programs executed by the CPU 201 and various data. A communication unit 209 communicates with external devices via a network such as the Internet or a local area network.

Programs may also be acquired via the communication unit 209 and stored in the storage unit 208.

A drive 210 connected to the input/output interface 205 drives an inserted removable medium 211 such as a magnetic disk, an optical disc, a magneto-optical disc, or semiconductor memory, and acquires information such as programs and data recorded thereon. Acquired programs and data are transferred to the storage unit 208 and stored as appropriate.

As illustrated in FIG. 14, a recording medium that records (stores) a program to be installed onto a computer in a computer-executable state may be a removable medium 211 as an instance of packaged media such as magnetic disks (including flexible disks), optical discs (including Compact Disc-Read-Only Memory (CD-ROM) and Digital Versatile Disc (DVD)), magneto-optical discs (including Mini-Disc (MD)), or semiconductor memory. Alternatively, such a recording medium may be the ROM 202 in which the program is transiently or permanently stored, or the hard disk constituting the storage unit 208. The recording of the program to the recording medium is conducted using a wired or wireless communication medium such as a local area network, the Internet, or digital satellite broadcasting via the communication unit 209, which may be a router, modem, or other interface as appropriate.

Note that, in this specification, the steps describing the foregoing series of processing operations obviously encompass processing operations conducted in a time series following the stated order, but also encompass operations executed in parallel or individually without strictly being processed in a time series.

Furthermore, the present disclosure is not limited to the foregoing first and second embodiments, and various modifications are possible within a scope that does not depart from the principal matter of the present disclosure.

The present disclosure contains subject matter related to that disclosed in Japanese Priority Patent Application JP 2012-182006 filed in the Japan Patent Office on Aug. 21, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A recording control apparatus comprising:
an acquisition unit that acquires media identification information identifying a recording medium, and recording location identification information identifying a recording medium that is a recording location for content; and
a recording control unit that causes the content to be recorded to the recording medium in the case where the media identification information matches the recording location identification information.

2. The recording control apparatus according to claim 1, further comprising:
a write unit that writes the media identification information already acquired by the acquisition unit to the recording unit as the recording location identification information associated with the content.

3. The recording control apparatus according to claim 2, wherein
the write unit writes the media identification information already acquired by the acquisition unit to the recording unit as the recording location identification information associated with content selected from among multiple instances of content.

4. The recording control apparatus according to claim 2, further comprising:
a content acquisition unit that acquires content;
wherein, from among the media identification information already acquired by the acquisition unit, the write unit writes the media identification information specified before the acquisition of the content to the recording unit as the recording location identification information associated with the content acquired from the content acquisition unit.

5. The recording control apparatus according to claim 4, wherein
the content acquisition unit is an imaging unit that acquires the content by taking an image of a subject.

6. The recording control apparatus according to claim 1, wherein
the acquisition unit acquires the media identification information from the recording medium in response to the recording medium being connected.

7. The recording control apparatus according to claim 6, wherein
the acquisition unit is a connection port connectable to the recording medium, and acquires the media identification information from the recording medium in response to the recording medium being connected to the connection port.

8. The recording control apparatus according to claim 1, wherein
the acquisition unit also acquires folder identification information identifying a folder that is a recording location for the content from among multiple folders provided in the recording medium, and
the recording control unit causes the content to be recorded to a folder identified by the folder identification information in the case where the media identification information matches the recording location identification information.

9. The recording control apparatus according to claim 1, wherein
the recording control unit causes the content to be copied and recorded to the recording medium in the case where the media identification information matches the recording location identification information.

10. The recording control apparatus according to claim 1, wherein
the recording control unit causes the content to be moved and recorded to the recording medium in the case where the media identification information matches the recording location identification information.

11. A recording control method of a recording control apparatus that causes content to be recorded to a recording medium, comprising:
acquiring media identification information identifying a recording medium;
acquiring recording location identification information identifying a recording medium that is a recording location for content; and
causing the content to be recorded to the recording medium in the case where the media identification information matches the recording location identification information.

12. A program causing a computer to function as:
an acquisition control unit that controls the acquisition of media identification information identifying a recording medium, and the acquisition of recording location identification information identifying a recording medium that is a recording location for content; and
a recording control unit that causes the content to be recorded to the recording medium in the case where the media identification information matches the recording location identification information.
